(19) United States
(12) Patent Application Publication
(10) Pub. No.: US 2026/0002780 A1
(43) Pub. Date: Jan. 1, 2026

(54) LANDSLIDE VOLUME CALCULATION METHOD FUSING PRINCIPAL COMPONENT ANALYSIS AND VOXEL INTEGRATION

(71) Applicants: HOHAI UNIVERSITY, Jiangsu (CN); JIANGSU NANJING GEOLOGY ENGINEERING INVESTIGATION INSTITUTE, Jiangsu (CN)

(72) Inventors: Yueqian SHEN, Jiangsu (CN); Jundi JIANG, Jiangsu (CN); Jinguo WANG, Jiangsu (CN); Xu YANG, Jiangsu (CN)

(73) Assignees: HOHAI UNIVERSITY, Jiangsu (CN); JIANGSU NANJING GEOLOGY ENGINEERING INVESTIGATION INSTITUTE, Jiangsu (CN)

(21) Appl. No.: 18/880,563

(22) PCT Filed: Nov. 23, 2023
(86) PCT No.: PCT/CN2023/133659

§ 371 Date: Jan. 2, 2025

(30) Foreign Application Priority Data
Feb. 16, 2023 (CN) 202310120275.8

(51) Int. Cl. G01C 15/00

(52) U.S. Cl. CPC G01C 15/002

(57) ABSTRACT

A landslide volume calculation method fusing principal component analysis and voxel integration, comprising the steps of: collecting and registering bi-temporal point cloud data; establishing grids in a landslide area; calculating a normal vector of a point in each grid and a fitting planar function by using a principal component analysis method; calculating a volume variation of each grid by means of planar function integration; and calculating volume variations of all the grids, identifying an abnormal value by means of statistical analysis, and correcting the abnormal value. In the present disclosure, a landslide volume is efficiently and accurately calculated by using laser radar ranging technology and an acquired point cloud, constructing voxel units, fusing same with a principal component analysis method, and using voxel-based double integration to calculate volume variations inside voxels, thereby solving the problem of a volume result calculated by means of an average elevation being unreliable.

### TECHNICAL FIELD

The present disclosure belongs to the fields of geodetic measurement and photography measurement and remote sensing, a landslide volume calculation method based on laser radar point cloud, in particular to a landslide volume calculation method fusing principal component analysis and voxel integration.

### BACKGROUND

Landslide is one of the most common geological disasters, has the characteristics of large harm and wide distribution, and will threaten the life and property safety of people in severe cases. On the one hand, the monitoring on landslides can predict the occurrence of debris flow; on the other hand, the accurate calculation on the landslide mass can also predict the explosion range of the debris flow, thereby reducing related losses. Therefore, it is of great application value to carry out rapid, efficient, accurate and low-cost landslide identification and calculation.

The traditional method for detecting landslide deformation is mainly based on the “point” type measurement of the geodetic measurement technology, and the deformation information of the deformation monitoring point is measured by utilizing instruments such as a level and a total station, so as to predict and forecast the deformation of the landslide. In this method, although the accuracy of the measured monitoring points is high, the density of the points is low, the overall information of the landslide surface cannot be obtained, and the working efficiency is low, and the condition constraints such as terrain and meteorological are great.

In recent years, with the development of photogrammetry technology, the non-contact method for measuring the “surface” type acquisition data is also applied to landslide deformation monitoring. Landslide data are collected by utilizing the photogrammetry technology, and a three-dimensional model of the landslide is obtained through a data processing technology of photogrammetry professional software. The measurement method can obtain the planar measurement information, the measurement efficiency is high, but the measurement precision is less than the traditional geodetic measurement method.

In recent years, a rapidly developing laser radar technology provides a novel idea for landslide monitoring, and a laser radar technology emits a laser beam to a target, and then compares the received signal with a transmitted signal to obtain geometric parameters such as a distance, an orientation, and a height of the target, thereby achieving acquisition of high-resolution three-dimensional information on the target surface. The technology breaks through the traditional single-point measurement mode, and has the advantages of high efficiency, high resolution, high precision, high automation degree and non-contact, but how to provide a method capable of accurately calculating the volume of landslide is a technical problem to be discussed.

### SUMMARY

Objectives of the present disclosure: in view of the disadvantages in the prior art, provided by the present disclosure is a landslide volume calculation method fusing principal component analysis and voxel integration, by constructing a voxel unit, fusing a principal component analysis means, and utilizing a voxel double integration, the method calculates the volume variations in a voxel, achieves efficient and accurate calculation of the volume of the landslide, and eliminates the problem that the volume result is not reliable by adopting the average elevation.

Technical solutions: provided is a landslide volume calculation method fusing principal component analysis and voxel integration by the present disclosure, and the method includes following steps:
(1), a bi-temporal scanning on the same landslide collapse region is performed by adopting a laser scanning system, to obtain landslide surface point cloud data, and m targets are set at a periphery of the landslide, where m≥3, and an observation value for the laser scanning system is a three-dimensional coordinate of a landslide surface point;
(2), a conversion parameter Z for a bi-temporal point cloud coordinate through a three-dimensional coordinate conversion equation is calculated by utilizing the targets set in Step (1), and the point cloud is registered;
(3), the bi-temporal point cloud is grided by utilizing registered data obtained in Step (2), and a plane coordinate of each grid corner point is calculated;
(4), points of the bi-temporal point cloud are searched in each grid by using the plane grid corner point coordinates obtained in Step (3), and a grid with the small number of points is filtered; a normal vector and a fitting plane function of the bi-temporal point cloud are calculated in each grid by utilizing a principal component analysis means;
(5), a volume variation in each grid is calculated through the fitting plane function of the bi-temporal point cloud in each grid obtained in Step (4) by adopting a double integration, and a process is as follows;
The fitting plane function of the bi-temporal point cloud in the grid is assumed as f₁(x,y) and f₂(x,y), and the grid region is assumed as D, a calculation method for the volume variation V is:

$$V = \int {\int }_{D} {f}_{1} ( x , y ) - {f}_{2} ( x , y ) .$$

(6), an abnormal grid is identified according to the volume variation of all the grids obtained in Step (5) and a statistical analysis, by utilizing a mean value and a standard deviation of the volume variation of each grid;
(7), the abnormal grid identified in Step (6) is corrected, and a volume variation in the abnormal grid is recalculated, and a volume variation of a whole landslide is obtained.

In Step (1), in a process of the bi-temporal scanning, the targets are fixed.

In Step (2), in the three-dimensional coordinate conversion equation in Step (2),
let a matrix A be a three-dimensional coordinate of the point cloud in a coordinate system A, and a matrix B be a three-dimensional coordinate of the point cloud in a coordinate system B, the three-dimensional coordinate conversion equation between the coordinate system A and the coordinate system B is:

$${[ \begin{matrix}x \\ y \\ z\end{matrix} ]}_{B} = [ \begin{matrix}Δ x \\ Δ y \\ Δ z\end{matrix} ] + ( 1 + k ) {R [ \begin{matrix}x \\ y \\ z\end{matrix} ]}_{A} ,$$

where Δx denotes a X-direction translation amount of a coordinate origin. Δy denotes a Y-direction translation amount of the coordinate origin, Δz denotes a Z-direction translation amount of the coordinate origin, k denotes a scale factor, k=0, and R denotes a rotation matrix from the coordinate system A to the coordinate system B.

In a method for calculating the plane coordinate of the grid corner point in Step (3), a maximum value for a X coordinate of a landslide region is assumed as xₘₐₓ, a minimum value for the X coordinate is assumed as xₘᵢₙ, a maximum value for a Y coordinate is assumed as yₘₐₓ, a minimum value for the Y coordinate is assumed as yₘᵢₙ, a side length of the grid is assumed as d, a grid line number is assumed as m, and a method for calculating a column number n is:

$$m = \frac{{x}_{m ax} - {x}_{m i n}}{d} ;$$

$$n = \frac{{y}_{m ax} - {y}_{m i n}}{d} ;$$

letting i=1,2,3 . . . ,m, j=1,2,3 . . . ,n, plane coordinate boundaries x₀, x₁, y₀, y₁ of each grid are calculated according to m and n, and a calculation process is:

$${x}_{0} = {x}_{m i n} + i \times d ;$$

$${y}_{0} = {y}_{m i n} + j * d ;$$

$${x}_{1} = {x}_{0} + d ;$$

$${y}_{1} = {y}_{0} + d .$$

In a method for calculating the normal vector and the fitting plane function of the bi-temporal point cloud in each grid by utilizing the principal component analysis means in Step (4),
a three-dimensional coordinate of a point X in the gird is assumed as {Xᵢ=(xᵢ,yᵢ,zᵢ)|i=1, 2, . . . ;n}, and a corresponding covariance matrix C is constructed as:

$$C = \frac{1}{n} {M}^{T} M ,$$

where M=(X₁−X,̅X₂−X̅, . . . ,Xₙ−X̅), X̅=(X,Y,Z) denotes a barycentric coordinate of a point set, a principal component analysis is performed on the matrix C to obtain three characteristic values λ₁, λ₂, λ₃, and λ₁, λ₂, λ₃ are arranged in a descending order to obtain λ₁≥λ₂>λ₃>0, a feature vector corresponding to λ₃ is expressed as v₃=(A,B,C) and v₃ denotes the normal vector; and a calculation process of the fitting plane function is:

$$f ( x , y ) = - \frac{1}{C} ( A x + B y + D ) ,$$

$$where D = - ( A X + BY + CZ ) .$$

In a method for calculating a mean value and a standard deviation of the volume variation of all the grids in Step (6),
the volume variation of all the grids is set as

$${\{ {V}_{i} \}}_{i = 1}^{n} ,$$

and a calculation method according to the mathematical expectation μ and the standard deviation σ in the statistical analysis is:

$$μ = \frac{1}{n} {\sum }_{i = 1}^{n} {V}_{i} ,$$

$$σ = \sqrt{\frac{1}{n} {\sum }_{i = 1}^{n} {( {V}_{i} - μ )}^{2}} .$$

In Step (7), a process for correcting the abnormal grid is as follows.
(7.1), the normal vector {vᵢ=(xᵢ,yᵢ,zᵢ)|i=1, 2, . . . ,n} of a fitting plane on an arbitrary abnormal grid and nearby searched normal grids of the arbitrary abnormal grid is calculated through a principal component analysis means, and letting vᵢ=vᵢ, in a case where zᵢ<0
(7.2), a normal vector average value (a₁,b₁,c₁) for the nearby normal grids is obtained, and the average value projected onto a horizontal plane is expressed as n₁=(a₁,b₁), and (a1, b1) is considered as a protruding direction of an abnormal mountain.
(7.3), a projection n₂=(a₂,b₂) of the normal vector of the abnormal grid onto the horizontal plane is obtained, an included angle θ between n₁ and n₂ is calculated according to a following formula

$$θ = arc cos \frac{\vec{{n}_{1}} \cdot \vec{{n}_{2}}}{\vert \vec{{n}_{1}} \vert * \vert \vec{{n}_{2}} \vert} ,$$

and in a case where θ<90°, the abnormal mountain is considered as an external convex mountain body, otherwise, the abnormal mountain body is considered as a concave mountain body.
(7.4), in view of a problem of non-uniform point cloud density, a deviation d from each point on the abnormal grid to the fitting plane is calculated according to a following formula

$$d = \frac{A * x + B * y + C * z + D}{\sqrt{{A}^{2} + {B}^{2} + {C}^{2}}} ,$$

where A, B, C, and D denote fitting plane coefficients, and (x, y, z) denotes coordinate values for the points; and an expected u and a standard deviation σ of all points are calculated, a 95% confidence interval (μ−2σ,μ+2σ) is established, points outside the interval are considered as plane points, and rest points are considered as inclined points, and a maximum value xₘₐₓ for x, a minimum value xₘᵢₙ for x, a maximum value yₘₐₓ for y, and a minimum value yₘᵢₙ for y in coordinates of the inclined points are obtained; an inclined region D₁ is established by taking (xₘₐₓ,yₘₐₓ), (xₘₐₓ,yₘᵢₙ), (xₘᵢₙ,yₘₐₓ) and (xₘᵢₙ,yₘᵢₙ) as corner points, and a remaining region of the grid is taken as D₂.
(7.5), a concave-convex property of the mountain is determined according to 0 calculated in Step (7.3), and volumes of mountain bodies with different concave-convex properties are calculated according to following means.
(7.5.1), a volume V of the external convex mountain body is obtained by a following formula

$$V = {\int }_{{D}_{1}} \int f ( x , y ) + \overline{h} * {S}_{{D}_{2}} .$$

(7.5.2), a volume V of the concave mountain body is obtained by a following formula

$$V = {z}_{m ax} * {S}_{{D}_{1}} - {\int }_{{D}_{1}} \int {f}^{′} ( x , y ) + \overline{h} * {S}_{{D}_{2}} .$$

where f(x,y) denotes a function of x, y relative to z in the fitting plane of the inclined point, h̅ denotes an average height value for all points in the grid, S_{D}_{₁} denotes an area of a region D₁, S_{D}_{₂} denotes an area of a region D₂, zₘₐₓ denotes a maximum value for z, f′(x,y) denotes a function of x and y relative to z in a plane fitted by points obtained by subtracting a lowest point height among inclined points from all the inclined points.

Working principle: The process of a landslide volume calculation method fusing principal component analysis and voxel integration provided by the present disclosure is collecting and registering bi-temporal point cloud data; establishing grids in a landslide region; calculating a normal vector of a point in each grid and a fitting planar function by utilizing a principal component analysis means; calculating a volume variation of each grid by means of planar function integration; and calculating volume variations of all the grids, identifying an abnormal value by means of statistical analysis, and correcting the abnormal value, thereby achieving efficient and accurate calculation of the landslide volume.

Beneficial effects: in comparison with the prior art, the present disclosure has the following advantages.
(1) In comparison with the traditional DEM comparison method, the present disclosure utilizes double integration to calculate the volume variation within voxels, eliminating the problem of unreliable volume results calculated adopting average elevation.
(2) On the premise of ensuring accuracy, the present disclosure ensures the effective extraction of local planes within voxels.
(3) The method proposes a solution of abnormal grids, providing a foundation for further improving the applicability of the method of the present disclosure.

### BRIEF DESCRIPTION OF THE DRAWINGS

FIG. 1 illustrates a flowchart of a landslide volume calculation method fusing principal component analysis and voxel integration of the present disclosure.

FIG. 2 illustrates a schematic diagram of a station coordinate system of the present disclosure.

FIG. 3 illustrates a first temporal data grid projection graph.

FIG. 4 illustrates a second temporal data grid projection graph.

FIG. 5 illustrates a schematic diagram of a normal vector and a fitting plane in a grid of the present disclosure.

FIG. 6 illustrates a histogram diagram of the volume variation of the grid before a correction of the present disclosure.

FIG. 7 illustrates a histogram diagram of the volume variation less than 1 cubic meter of the grid before a correction of the present disclosure.

FIG. 8 illustrates a histogram diagram of the volume variation greater than 1.5 cubic meter of the grid before a correction of the present disclosure.

FIG. 9 illustrates a histogram diagram of the volume variation of the grid after a correction of the present disclosure.

### DESCRIPTION OF THE EMBODIMENTS

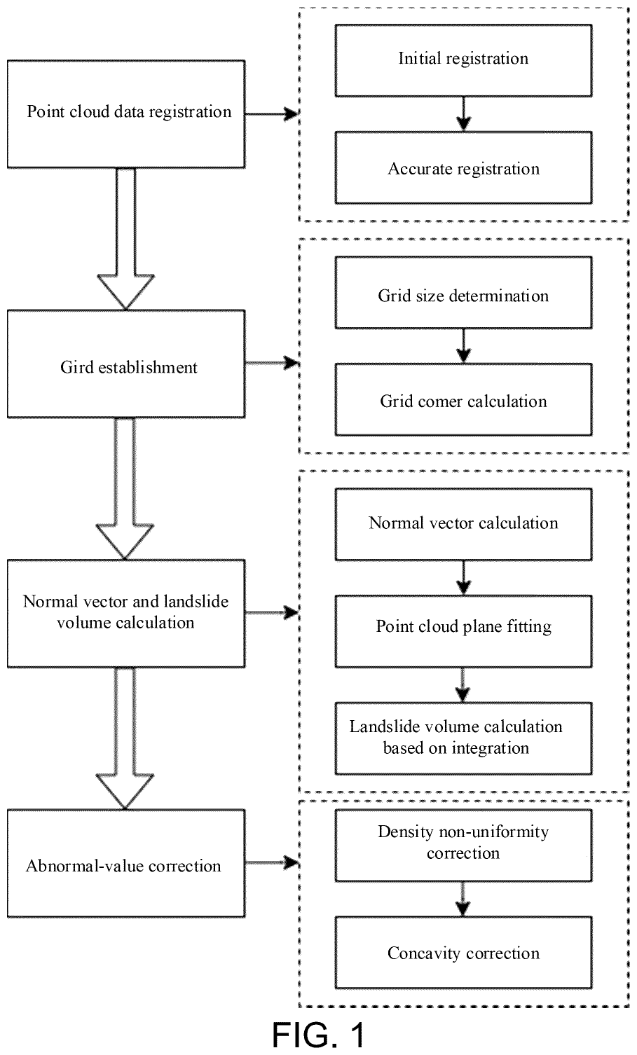

As illustrated in FIG. 1, provided is a landslide volume calculation method fusing principal component analysis and voxel integration by the present disclosure, and the method includes following steps.
(1), a bi-temporal scanning on the same landslide collapse region is performed by adopting a laser scanning system, to obtain landslide surface point cloud data, and m targets are set at a periphery of the landslide, where m≥3, and an observation value for the laser scanning system is a three-dimensional coordinate of a landslide surface point.
(2), a conversion parameter Z for a bi-temporal point cloud coordinate through a three-dimensional coordinate conversion equation is calculated by utilizing the targets set in Step (1), and the point cloud is registered.
(3), the bi-temporal point cloud is grided by utilizing the registered data obtained in Step (2), and a plane coordinate of each grid corner point is calculated.
(4), points of the bi-temporal point cloud are searched in each grid by utilizing the plane grid corner point coordinates obtained in Step (3), and a grid with the small number of points is filtered; a normal vector and a fitting plane function of the bi-temporal point cloud are calculated in each grid by utilizing a principal component analysis means.
(5), a volume variation in each grid is calculated through the fitting plane function of the bi-temporal point cloud in each grid obtained in Step (4) by adopting a double integration, and a process is as follows.

The fitting plane function of the bi-temporal point cloud in the grid is assumed as f₁(x,y) and f₂(x,y), and the grid region is assumed as D, a calculation method for the volume variation V is:

$$V = \int {\int }_{D} {f}_{1} ( x , y ) - {f}_{2} ( x , y ) .$$

(6), an abnormal grid is identified according to the volume variation of all the grids obtained in Step (5) and a statistical analysis, by utilizing a mean value and a standard deviation of the volume variation of each grid.
(7), the abnormal grid identified in Step (6) is corrected, and a volume variation in the abnormal grid is recalculated, and a volume variation of a whole landslide is obtained.

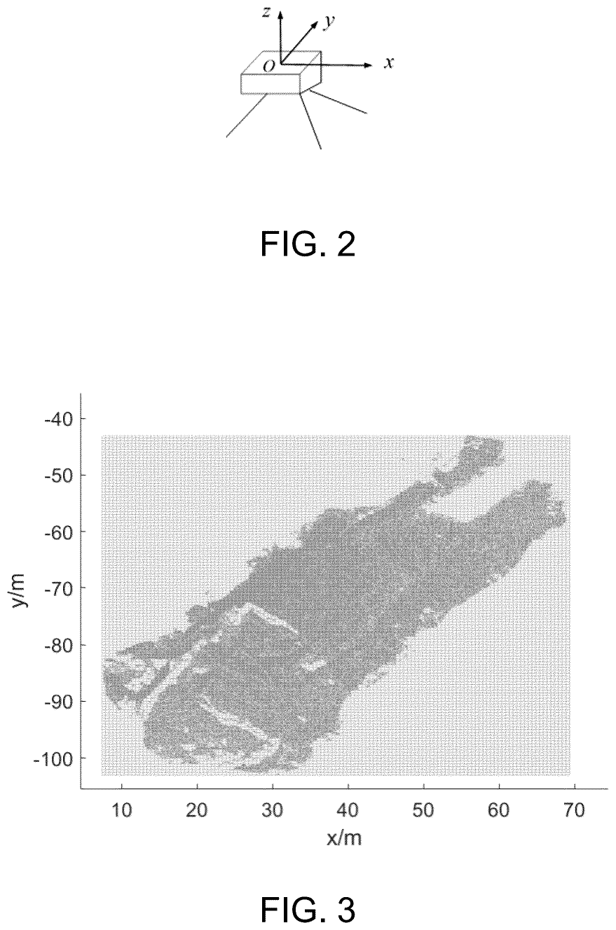

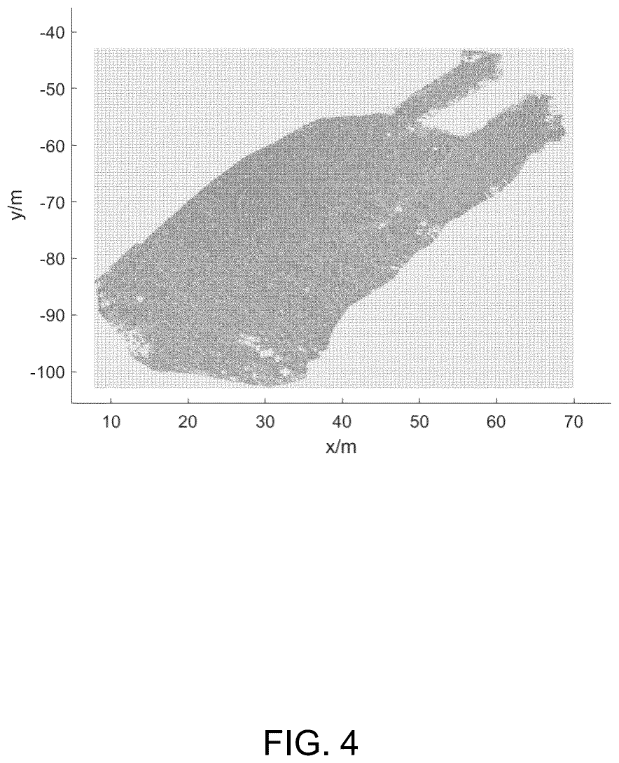

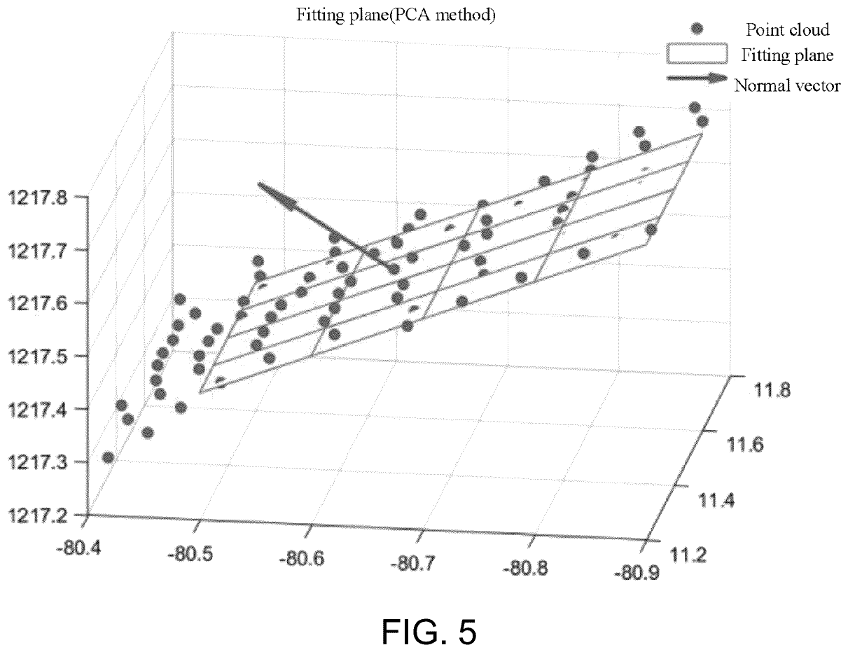

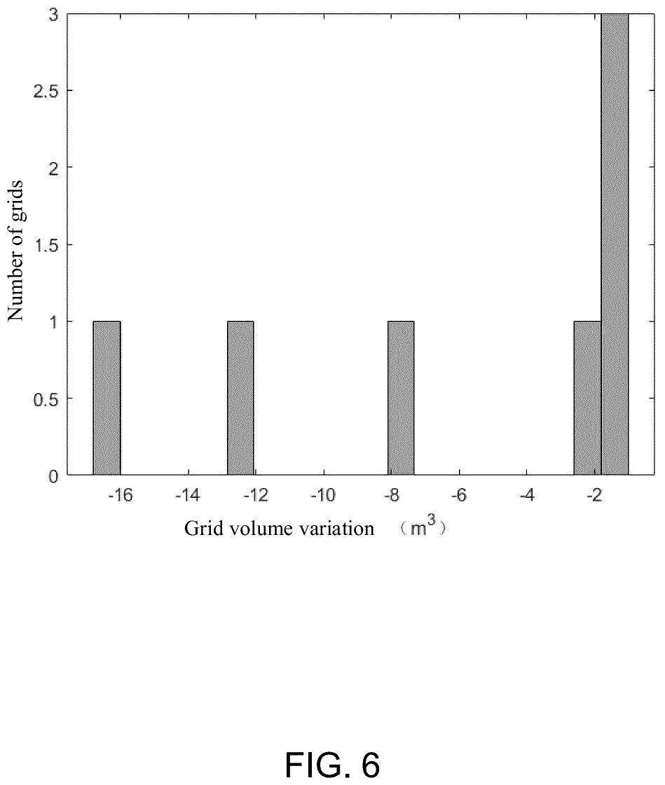

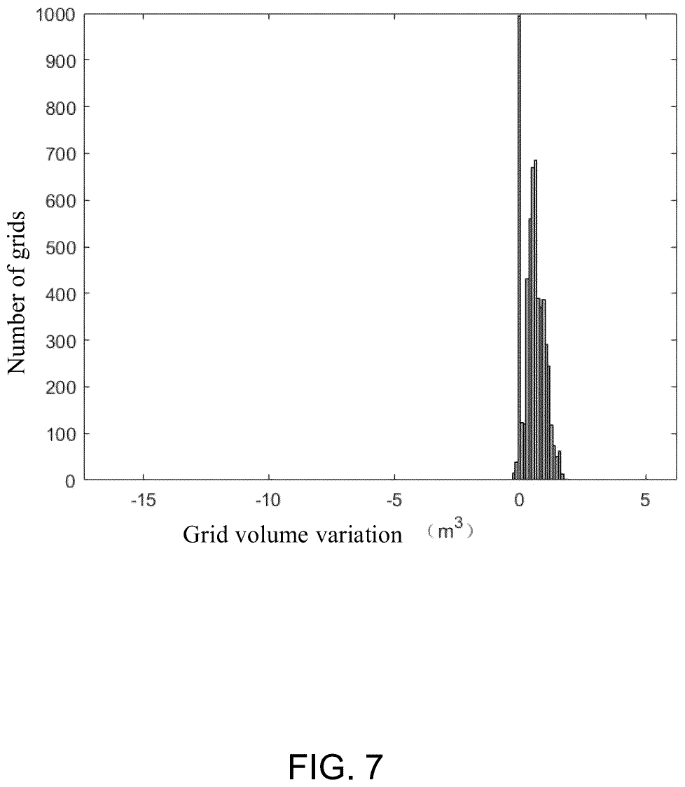

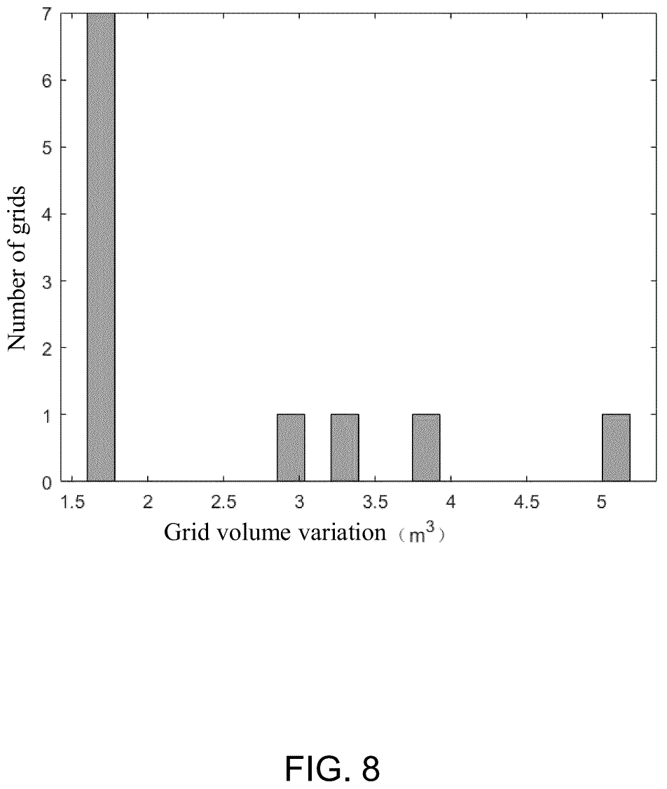

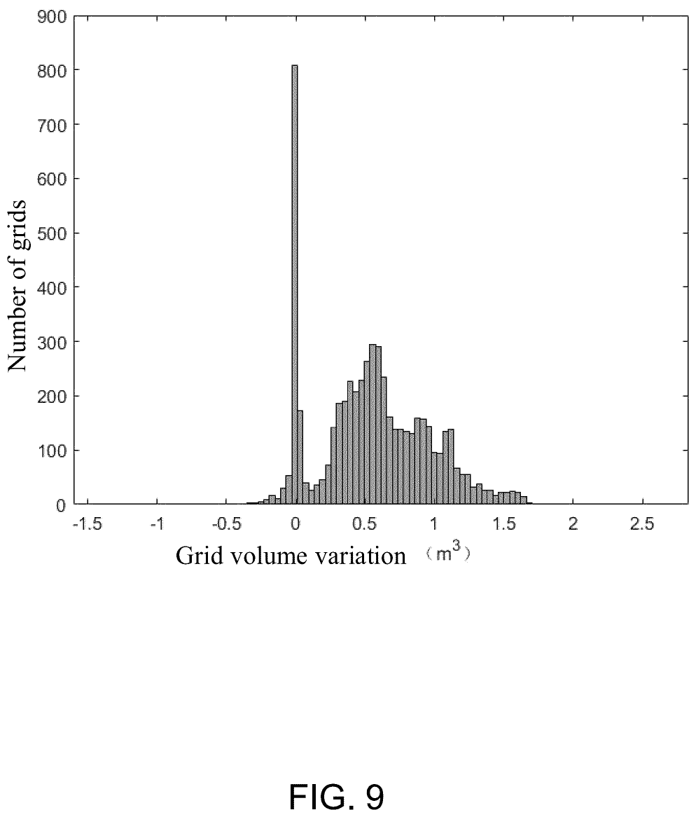

Taking the “landslide variation detection on a construction site in a certain residential region” as an example, the present disclosure is further described as follows.
(1) The landslide subsidence region is scanned by utilizing a FARO FocusS Plus350 scanner, four targets are arranged in the stable region outside the experimental region, and the interval time between bi-temporal scanning is 5 days; and laser point cloud data on the surface of the bi-temporal landslide are obtained, and the observation value is the three-dimensional coordinate.
(2) As illustrated in FIG. 2, the station is taken as the center and the vertical direction is taken as the Z axis, the target set in Step (1) is utilized to calculate a conversion parameter Z for the bi-temporal point cloud coordinate, and the second-temporal point cloud coordinate is registered to the first-temporal point cloud station coordinate system to complete the registration.
(3) As illustrated in FIG. 3 and FIG. 4, the registration data obtained in Step (2) are utilized to perform a griding on the registered bi-temporal point cloud, the maximum and minimum values for the landslide region points X and Y coordinates are respectively xₘₐₓ=69.0271 m, xₘᵢₙ=7.7483 m, yₘₐₓ=−43.1452 m, and yₘᵢₙ=−102.8868 m, the grid side length is 0.5 m, and the plane coordinate of each grid corner point is calculated.
(4) As illustrated in FIG. 5, the plane grid corner point coordinates obtained in Step (3) are utilized to search the points of the bi-temporal point cloud in each grid, the point number threshold is set as n₀=10, and the grid with extremely little number of points is filtered. A normal vector and a fitting plane function of the bi-temporal point cloud in each grid are calculated by utilizing a principal component analysis means.
(5) The volume variation in each grid is calculated through the fitting plane function of the bi-temporal point cloud in each grid obtained in Step (4) by utilizing a double integration, and the result is as illustrated in FIG. 6 to FIG. 8.
(6) According to the volume variation of all the grids obtained in Step (5), the mathematical expectation μ=0.5453 m³ and the standard deviation σ=0.5170 m³ of the volume variation of the grids are calculated. According to the statistical analysis, (μ−2σ,μ+2σ) is a 95% confidence interval, and the grid of volume variations are extracted outside the confidence interval.
(7) The grid obtained in Step (6) is considered as an abnormal grid, the points in the abnormal grid are considered as abnormal points, the abnormal grid correction is performed on these points, the volume variation in the abnormal grid is recalculated, the histogram diagram of the volume variation of the grid after the correction is as illustrated in FIG. 9, and eventually all landslide volumes are obtained as 3111.7225 m³.

1. A landslide volume calculation method fusing principal component analysis and voxel integration, comprising following steps:
Step (1), performing, by adopting a laser scanning system, a bi-temporal scanning on a same landslide collapse region, to obtain landslide surface point cloud data, and setting m targets at a periphery of the landslide, wherein m≥3, and an observation value for the laser scanning system is a three-dimensional coordinate of a landslide surface point;
Step (2), calculating, by utilizing the targets set in Step (1), a conversion parameter Z for a bi-temporal point cloud coordinate through a three-dimensional coordinate conversion equation, and registering a point cloud;
Step (3), gridding, by utilizing registered data obtained in Step (2), the bi-temporal point cloud, and calculating a plane coordinate of each grid corner point;
Step (4), searching, by utilizing the plane grid corner point coordinates obtained in Step (3), points of the bi-temporal point cloud in each grid, and filtering a grid with a small number of points; calculating, by utilizing a principal component analysis means, a normal vector and a fitting plane function of the bi-temporal point cloud in each grid;
Step (5), calculating, by adopting a double integration, a volume variation in each grid through the fitting plane function of the bi-temporal point cloud in each grid obtained in Step (4); wherein a process is that:
the fitting plane function of the bi-temporal point cloud in the grid is assumed as f₁(x,y) and f₂(x,y), and a grid region is assumed as D, a calculation method for the volume variation V is:
$$V = \int {\int }_{D} {f}_{1} ( x , y ) - {f}_{2} ( x , y ) ;$$
Step (6), identifying, according to the volume variation of all the grids obtained in Step (5) and a statistical analysis, an abnormal grid by utilizing a mean value and a standard deviation of the volume variation of each grid;
Step (7), correcting the abnormal grid identified in Step (6), recalculating the volume variation in the abnormal grid, and obtaining the volume variation of a whole landslide.

2. The landslide volume calculation method fusing principal component analysis and voxel integration according to claim 1, wherein in Step (1), in a process of the bi-temporal scanning, the targets are fixed.

3. The landslide volume calculation method fusing principal component analysis and voxel integration according to claim 1, wherein in the three-dimensional coordinate conversion equation in Step (2):
let a matrix A be a three-dimensional coordinate of the point cloud in a coordinate system A, and a matrix B be the three-dimensional coordinate of the point cloud in the coordinate system B, the three-dimensional coordinate conversion equation between the coordinate system A and the coordinate system B is:
$${[ \begin{matrix}x \\ y \\ z\end{matrix} ]}_{B} = [ \begin{matrix}Δ x \\ Δ y \\ Δ z\end{matrix} ] + ( 1 + k ) {R [ \begin{matrix}x \\ y \\ z\end{matrix} ]}_{A} ,$$
where Δx denotes a X-direction translation amount of a coordinate origin, Δy denotes a Y-direction translation amount of the coordinate origin, Δz denotes a Z-direction translation amount of the coordinate origin, k denotes a scale factor, k=0, and R denotes a rotation matrix from the coordinate system A to the coordinate system B.

4. The landslide volume calculation method fusing principal component analysis and voxel integration according to claim 1, wherein in a method for calculating the plane coordinate of the grid corner point in Step (3):
a maximum value for a X coordinate of a landslide region is assumed as xₘₐₓ, a minimum value for the X coordinate is assumed as xₘᵢₙ, a maximum value for a Y coordinate is assumed as yₘₐₓ, a minimum value for the Y coordinate is assumed as yₘᵢₙ, a side length of the grid is assumed as d, a grid line number is assumed as m, and a method for calculating a column number n is:
$$m = \frac{{x}_{m ax} - {x}_{m i n}}{d} ;$$
$$n = \frac{{y}_{m a x} - {y}_{m i n}}{d} ;$$
letting i=1,2,3 . . . ,m j=1,2,3 . . . ,n plane coordinate boundaries x₀, x₁, y₀, y₁ of each grid are calculated according to m and n, and a calculation process is:
$${x}_{0} = {x}_{m i n} + i \times d ;$$
$${y}_{0} = {y}_{m i n} + j * d ;$$
$${x}_{1} = {x}_{0} + d ;$$
$${y}_{1} = {y}_{0} + d .$$

5. The landslide volume calculation method fusing principal component analysis and voxel integration according to claim 1, wherein in a method for calculating the normal vector and the fitting plane function of the bi-temporal point cloud in each grid by utilizing the principal component analysis means in Step (4):
a three-dimensional coordinate of a point X in the gird is assumed as {Xᵢ=(xᵢ,yᵢ,zᵢ)|i=1, 2, . . . , n}, and a corresponding covariance matrix C is constructed as:
$$C = \frac{1}{n} {M}^{T} M ,$$
where M=(X₁−X̅,X₂−X̅, . . . ,Xₙ−X̅)^{T}, X̅=(X,Y,Z) denotes a barycentric,
coordinate of a point set, a principal component analysis is performed on the matrix C to obtain three characteristic values λ₁, λ₂, λ₃, and λ₁, λ₂, λ₃ are arranged in a descending order to obtain λ₁≥λ₂>λ₃>0, a feature vector corresponding to λ₃ is expressed as v₃=(A,B,C), and v₃ denotes the normal vector; and a calculation process of the fitting plane function is:
$$f ( x , y ) = - \frac{1}{C} ( A x + B y + D ) ,$$
$$where D = - ( A X + BY + CZ ) .$$

6. The landslide volume calculation method fusing principal component analysis and voxel integration according to claim 1, wherein in a method for calculating the mean value and the standard deviation of the volume variation of all the grids in Step (6):
the volume variation of all the grids is set as
$${\{ {V}_{i} \}}_{i = 1}^{n} ,$$
and a calculation method according to a mathematical expectation μ and the standard deviation σ in the statistical analysis is:
$$μ = \frac{1}{n} {\sum }_{i = 1}^{n} {V}_{i} ,$$
$$σ = \sqrt{\frac{1}{n} {\sum }_{i = 1}^{n} {( {V}_{i} - μ )}^{2}} .$$

7. The landslide volume calculation method fusing principal component analysis and voxel integration according to claim 1, wherein in Step (7), a process for correcting the abnormal grid is:
Step (7.1), calculating, through the principal component analysis means, the normal vector {vᵢ=(xᵢ,yᵢ,zᵢ)|i=1,2, . . . ,n} of a fitting plane on an arbitrary abnormal grid and nearby searched normal grids of the arbitrary abnormal grid, and letting, in a case where zᵢ<0, vᵢ=−vᵢ;
Step (7.2), obtaining a normal vector average value (a₁,b₁,c₁) for the nearby normal grids, and expressing the average value projected onto a horizontal plane as n₁=(a₁,b₁) and considering (a1, b1) as a protruding direction of an abnormal mountain;
Step (7.3), obtaining a projection n₂=(a₂,b₂) of the normal vector of the abnormal grid onto the horizontal plane, calculating, according to a following formula
$$θ = arc cos \frac{\vec{{n}_{1}} \cdot \vec{{n}_{2}}}{\vert \vec{{n}_{1}} \vert * \vert \vec{{n}_{2}} \vert} ,$$
an included angle θ between n₁ and n₂, and considering, in a case where θ<90°, that the abnormal mountain is an external convex mountain body, otherwise, the abnormal mountain body is a concave mountain body;
Step (7.4), calculating, in view of a problem of non-uniform point cloud density, a deviation d from each point on the abnormal grid to the fitting plane according to a following formula
$$d = \frac{A * x + B * y + C * z + D}{\sqrt{{A}^{2} + {B}^{2} + {C}^{2}}} ,$$
where A, B, C, and D denote fitting plane coefficients, and (x, y, z) denotes coordinate values for the points; and calculating an expected μ and a standard deviation σ of all points, establishing a 95% confidence interval (μ−2σ,μ+2σ), considering points outside the interval as plane points, and considering rest points as inclined points, and obtaining a maximum value xₘₐₓ for x, a minimum value xₘᵢₙ for x, a maximum value yₘₐₓ for y, and a minimum value yₘᵢₙ for y in coordinates of the inclined points; establishing, by taking (xₘₐₓ,yₘₐₓ), (xₘₐₓ,yₘᵢₙ), (xₘᵢₙ,yₘₐₓ) and (xₘᵢₙ,yₘᵢₙ) as corner points, an inclined region D₁, and taking a remaining region of the grid as D₂;
Step (7.5), determining, according to θ calculated in Step (7.3), a concave-convex property of the mountain, and calculating, according to following means, volumes of mountain bodies with different concave-convex properties:
Step (7.5.1), obtaining, by a following formula
$$V = {\int }_{{D}_{1}} \int f ( x , y ) + \overline{h} * {S}_{{D}_{2}} ,$$
a volume V of the external convex mountain body;
Step (7.5.2), obtaining, by a following formula
$$V = {z}_{m ax} * {S}_{{D}_{1}} - {\int }_{{D}_{1}} \int {f}^{′} ( x , y ) + \overline{h} * {S}_{{D}_{2}} ,$$
a volume V of the concave mountain body;
where f(x,y) denotes a function of x, y relative to z in the fitting plane of the inclined point, ĥ denotes an average height value for all points in the grid, S_{D}_{₁} denotes an area of a region D₁, S_{D}_{₂} denotes the area of the region D₂, zₘₐₓ denotes a maximum value for z, f′(x,y) denotes a function of x and y relative to z in a plane fitted by points obtained by subtracting a lowest point height among inclined points from all the inclined points.
